(19) United States
(12) Patent Application Publication
(10) Pub. No.: US 2026/0218768 A1
(43) Pub. Date: Jul. 30, 2026

(54) TECHNIQUES FOR DAMPING RESONANCES

(71) Applicant: Honeywell International Inc., Charlotte, NC (US)

(72) Inventor: Chad E Richason, Seminole, FL (US)

(73) Assignee: Honeywell International Inc., Charlotte, NC (US)

(21) Appl. No.: 19/039,270

(22) Filed: Jan. 28, 2025

(51) Int. Cl. F16F 7/108; G01P 1/00

(52) U.S. Cl. CPC F16F 7/108; G01P 1/003; F16F 2222/08

(57) ABSTRACT

Techniques are provided in which an additional, or second, spring mass system is added to a first spring mass system. The second spring mass system is configured to diminish, or dampen, an amplitude of the resonance of the first spring mass system. Thus, a combination of the first and the second spring mass systems has a diminished amplitude of such resonance. An amplitude of vibrations in a frequency band around the resonance is diminished. As a result, bias error of the inertial system is diminished.

### BACKGROUND

Vibrations in an inertial system are subject to vibrations. Such vibrations can cause measurement errors, require a more complicated control system to compensate for such vibrations. To diminish the vibrations, inertial sensors, e.g., accelerometer(s) and/or gyroscope(s), are each attached to a chassis with a first set of one or more elastomers.

The combination of the elastomer and a mass of the inertial system create a spring mass system with a natural (or resonant) frequency. At and around such resonant frequency, vibrations of the spring mass system, e.g., the inertial system, are amplified. Such amplified vibrations induce increased energy in the inertial system which causes undesirable bias errors in sensor(s) of the inertial system.

### SUMMARY

In some aspects, the techniques described herein relate to an apparatus for reducing error in an inertial system, the apparatus including: the inertial system including a package and at least one inertial sensor each of which is attached in and/or on the package; a first set of one or more elastomeric isolators mechanically coupling the package to a chassis; one or more balance weights; and a second set of one or more elastomeric isolators, wherein each of the one or more balance weights is mechanically coupled to the package by one or more elastomeric isolators of the second set.

In some aspects, the techniques described herein relate to a method for reducing error in an inertial system, the method including: receiving a vibration in the inertial system which is attached to a chassis by a first set of one or more elastomeric isolators, wherein the inertial system includes a package and at least one inertial sensor each of which is attached in and/or on the package; and diminishing an amplitude of the vibration in the inertial system with one or more balance weights each of which is mechanically coupled to the package by at least one of a second set of one or more elastomeric isolators.

In some aspects, the techniques described herein relate to an apparatus for reducing error in an inertial system, the apparatus including: a chassis of a vehicle; the inertial system including a package and at least one inertial sensor each of which is attached in and/or on the package, wherein the at least one inertial sensor includes at least one accelerometer and/or at least one gyroscope; a first set of one or more elastomeric isolators mechanically coupling the package to the chassis; one or more balance weights; and a second set of one or more elastomeric isolators, wherein each of the one or more balance weights is mechanically coupled to the package by one or more elastomeric isolators of the second set.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 illustrates a lumped parameter diagram of a second spring mass system coupled to a first spring mass system;

FIG. 2 illustrates a diagram of one embodiment of a first amplitude versus frequency response of a first spring mass system, and a second amplitude versus frequency response of the first spring mass system with the second spring mass system coupled to the first spring mass system;

FIG. 3A illustrates three dimensional diagram of an inertial system according to one embodiment of the invention;

FIG. 3B illustrates three dimensional diagram of an inertial system according to another embodiment of the invention; and

FIG. 4 illustrates a flow diagram of an exemplary method for diminishing an amplitude of a vibration in a resonant frequency band about a resonant frequency of an inertial system and a first set of elastomer(s) coupled to the inertial system.

In accordance with common practice, the various described features are not drawn to scale but are drawn to emphasize specific features relevant to the exemplary embodiments. Reference characters denote like elements throughout figures and text.

### DETAILED DESCRIPTION

In the following detailed description, reference is made to the accompanying drawings that form a part hereof, and in which is shown by way of illustration specific illustrative embodiments. However, it is to be understood that other embodiments may be utilized, and that structural, mechanical, and/or electrical changes may be made. Furthermore, each method presented in the drawing figures and the specification is not to be construed as limiting the order in which the individual steps may be performed. The following detailed description is not to be taken in a limiting sense.

In embodiments of the invention, an additional, or second, spring mass system is added to the spring mass system (or first spring mass system). The second spring mass system is configured to diminish, or dampen, an amplitude of the resonance of the first spring mass system. Thus, a combination of the first and the second spring mass systems has a diminished amplitude of such resonance. An amplitude of vibrations in a frequency band around the resonance is diminished. As a result, bias error of the inertial system is diminished.

The second spring mass system comprises a second set of one or more elastomers. The second set of one or more elastomers is coupled, e.g., mechanically coupled, to one or more balance weights. Thus, one or more elastomers of the second set is coupled to one of the balance weights. The balance weights can also be used to align a center of gravity and a center of isolation of the inertial system, e.g., a set of accelerometer(s) and/or a set of gyroscope(s) therein, to diminish random movement thereof; as a result, error of the inertial system, e.g., of each set, is diminished. Each of an accelerometer and a gyroscope may be referred to herein as an inertial sensor. In embodiments of the invention, the mass of the second balance weights and a spring constant and/or damping factor of the second set is selected to diminish an amplitude in the resonant frequency band, e.g., at the resonant frequency. Elastomer(s) may also be referenced herein as elastomer isolator(s).

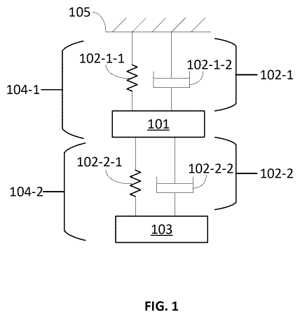

FIG. 1 illustrates a lumped parameter diagram of a second spring mass system 104-2 coupled, e.g., mechanically coupled, to a first spring mass system 104-1. The first spring mass system 104-1 includes the first set of one or more elastomers 102-1 coupled to the inertial system 101 which has a first mass. Optionally, the inertial system 101 may be an inertial measurement unit, an inertial navigation system, a attitude heading reference system, or any other type of inertial system.

The first set of one or more elastomers 102-1 couples the inertial system 101 to the chassis 105. Optionally, the chassis 105 is a chassis of an entity, for example of a human, an animal, a vehicle (e.g., an aircraft), or any other type of thing. Thus, for example, a first end of each of the first set 102-1 is coupled to the inertial system 101; a second end, opposite the first end, of each of the first set 102-1 is coupled to the chassis 105. Each elastomer, and thus each elastomer set, acts as a spring.

The second spring mass system 104-2 includes the second set of one or more elastomers 102-2 and balance weights 103. The second set of one or more elastomers 102-2 couples, e.g., mechanically couples, the one or more balance weights 103 to the inertial system 101. Thus, for example, a first end of each of the second set 102-2 is coupled to the inertial system 101; a second end, opposite the first end, of each of the second set 102-2 is coupled to one or more of the balance weight(s) 103.

In FIG. 1, each set of one or more elastomers is represented in lump parameter model form as having a spring constant 102-1-1, 102-2-1 and a damping factor 102-2-2. The resonance frequency of a single spring mass system is a function of spring constant of the single spring mass system divided by the mass of the single spring mass system.

The first set of one or more elastomers 102-1 has a first spring constant 102-1-1 and a first damping coefficient 102-1-2. The second set of one or more elastomers 102-2 has a second spring constant 102-1-1 and a second damping coefficient 102-2-2.

The mass of the one or more balance weights, the second spring constant 102-2-1, and/or the second damping constant 102-2-2 are selected to diminish an amplitude at and/or about the resonance of the first spring mass system 104-1. Optionally, at least one of: (a) the spring constant of the second set, (b) the damping constant of the second set, and (c) the mass of the one or more balance weights is chosen as a function of at least one of: (i) the spring constant of the first set, (ii) the damping constant of the first set, and (iii) the mass of the inertial system. Optionally, at least one of: (a) the first spring constant 102-1-1 equals the second spring constant 102-2-1; (b) the first damping constant 102-1-2 equals the second damping constant 102-2-2; (c) the mass of the inertial system equals the mass of the one or more balance weights, and (d) a frequency response of the first set equals the frequency response of the second set. Optionally, a mass of the one or more balance weights is greater than three percent of a sum of a mass of the inertial system. Optionally, a spring constant and a damping constant of each elastomeric isolator of the first set equals a spring constant and a damping constant of each elastomeric isolator of the second set

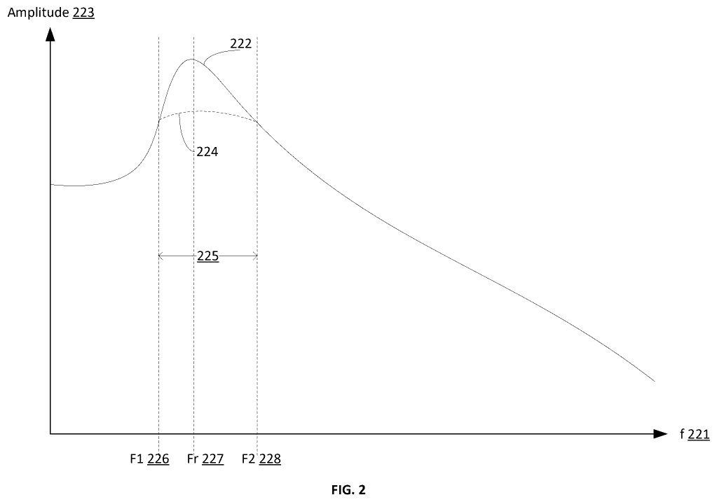

FIG. 2 illustrates a diagram of one embodiment of a first amplitude versus frequency response 222 of a first spring mass system, and a second amplitude versus frequency response 224 of the first spring mass system with the second spring mass system coupled to the first spring mass system. The Y axis is of amplitude 223. The X axis is of frequency 221. The addition of the second spring mass system 104-2 to the first spring mass system 104-1 diminishes, e.g., dampens, the amplitude response in a resonant frequency band 225 around a resonant frequency (Fr) 227 of the first spring mass system 104-1. Optionally, the resonant frequency band 225 is defined by two, e.g., 3 decibel (dB), a first corner frequency F1 226 and a second corner frequency F2 228.

Akin to what is shown in FIG. 2, the second spring mass system 104-2 has its own amplitude versus frequency response whose characteristics, including a resonant frequency and resonant frequency band are defined by the spring constant and damping factor of the second set of one or more elastomers 102-2 and a mass of the balance weights 103. Optionally, a resonant frequency of the second spring mass system 104-2 is no more than thirty five percent different than the resonant frequency of the first spring mass system 104-1.

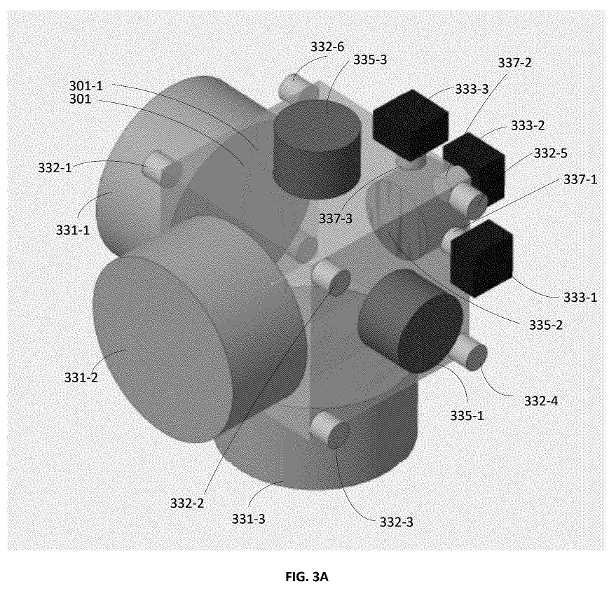

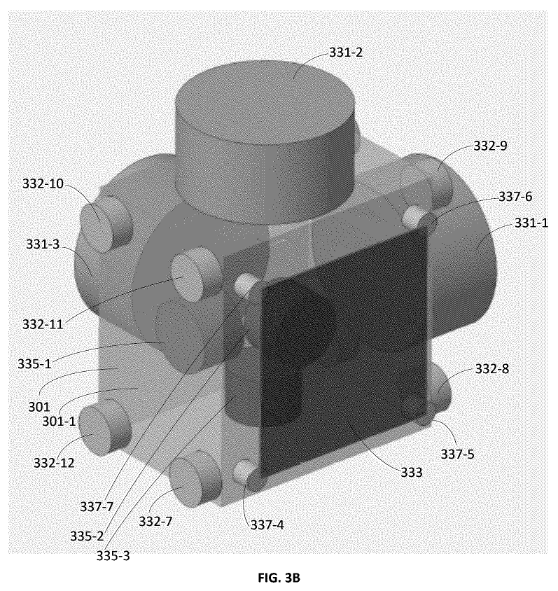

FIG. 3A illustrates three dimensional diagram of an inertial system 301 according to one embodiment of the invention. The inertial system 301 included at least one, e.g., three, accelerometer 335-1, 335-2, 335-3 and/or at least one, e.g., three, gyroscopes 331-1, 331-2, 331-3. Each accelerometer and gyroscope is attached in and/or on the package 301-1 of the inertial system 301. For pedagogical purposes, the inertial system 301 is illustrated with three accelerometers and three gyroscopes.

The inertial system 301 is configured to be coupled to a chassis by a first set of one or more elastomers 332-1, 332-2, 332-3, 332-4, 332-5, 332-6. A first end of each of the first set of one or more elastomers 332-1, 332-2, 332-3, 332-4, 332-5, 332-6 is coupled to the inertial system 301. A second end, opposite the first end, of each of the first set of one or more elastomers 332-1, 332-2, 332-3, 332-4, 332-5, 332-6 is configured to be coupled to the chassis 105.

A second spring mass system 104-2 is attached to the inertial system 301, e.g., the first spring mass system 104-1. At least one, e.g., only one, of one or more balance weights 333-1, 333-2, 333-3 of the second spring mass system 104-2, is coupled by at least one, e.g., only one, elastomer of the second set of elastomers 337-1, 337-2, 337-3 to the inertial system 301, e.g. a package 301-1 thereof. A first end of each elastomer of the second set 337-1, 337-2, 337-3 is coupled to the inertial system 301, e.g., the package 301-1 thereof. A second end of each elastomer of the second set 337-1, 337-2, 337-3 is coupled to at least one, e.g., only one, of one or more balance weights 333-1, 333-2, 333-3. Optionally, two of the one or more balance weight are coupled, e.g., mechanically coupled, by elastomer(s) of the second set to orthogonal surfaces of the package.

FIG. 3B illustrates three dimensional diagram of an inertial system 301 according to another embodiment of the invention. The embodiment of FIG. 3B differs from 3A in that the embodiment of FIG. 3B illustrates the use of a single balance weight 333 (in lieu of two or more balance weights 333-1, 333-2, 333-3 as exemplified in FIG. 3A) coupled, e.g., mechanically coupled, to the package 301-1 by a second set of one or more elastomers 337-4, 337-5, 337-6, 337-7. In FIG. 3B, the inertial system 301 is configured to be coupled to a chassis by a first set of one or more elastomers 332-7, 332-8, 332-9, 332-10, 332-11, 332-12.

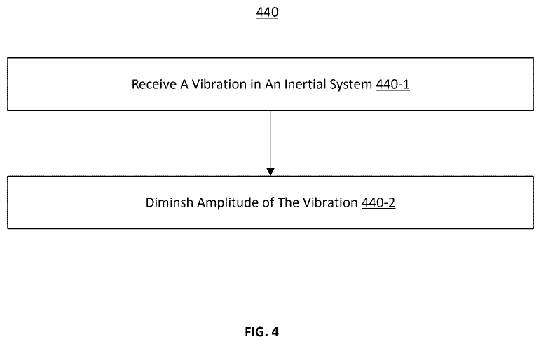

FIG. 4 illustrates a flow diagram of an exemplary method 440 for diminishing an amplitude of a vibration in a resonant frequency band about a resonant frequency of an inertial system and a first set of elastomer(s) coupled to the inertial system. The resonant frequency is established by a mass of the inertial system and a spring constant of the first set. A set of balance weights is coupled to the inertial system by a second set of elastomer(s). In embodiments of the invention, the mass of the second balance weights and a spring constant and/or damping factor of the second set is selected to diminish an amplitude in the resonant frequency band, e.g., at the resonant frequency.

Exemplary method 440 may be implemented by one or more of the apparatuses illustrated in FIGS. 1-3B. To the extent the methods herein are described herein as being implemented with one or more of the apparatuses illustrated in FIGS. 1-3B, it is to be understood that other embodiments can be implemented in other ways. Techniques described with respect to the embodiments illustrated by FIGS. 1-3B may be applicable to the method 440.

The blocks of the flow diagrams herein have been arranged in a generally sequential manner for ease of explanation; however, it is to be understood that this arrangement is merely exemplary, and it should be recognized that the processing associated with the methods (and the blocks shown in the Figures) can occur in a different order (for example, where at least some of the processing associated with the blocks is performed in parallel and/or in an event-driven manner). Optionally, the following blocks are performed during the fourth time period.

In block 440-1, a vibration, in the resonant frequency band (e.g., the resonant frequency), is received in an inertial system coupled to a chassis by a first set of one or more elastomers. The inertial system and elastomer have a resonant frequency which is established by a mass of the inertial system and a spring constant of the first set.

In block 440-2, the amplitude of the vibration is diminished by the set of one or more balance weights and a second set of one or more elastomers. The one or more balance weights are coupled to the inertial system by the second set. Optionally, at least one of: (a) the spring constant of the second set, (b) the damping constant of the second set, and (c) the mass of the one or more balance weights is chosen as a function of at least one of: (i) the spring constant of the first set, (ii) the damping constant of the first set, and (iii) the mass of the inertial system. Optionally, at least one of: (a) the spring constant of the first set equals the spring constant of the second set; (b) the damping constant of the first set equals the damping constant of the second set; and (c) the mass of the inertial system equals the mass of the one or more balance weights. Optionally, a mass of the one or more balance weights is greater than three percent of a sum of a mass of the inertial system. Optionally, a spring constant and a damping constant of each elastomeric isolator of the first set equals a spring constant and a damping constant of each elastomeric isolator of the second set.

While the present teachings have been illustrated with respect to one or more implementations, alterations and/or modifications can be made to the illustrated examples without departing from the scope of the appended claims. In addition, while a particular feature of the present disclosure may have been described with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and/or the claims, such terms are intended to be inclusive in a manner similar to the term “comprising.” The term “at least one of” is used to mean one or more of the listed items can be selected. As used herein, the term “one or more of” with respect to a listing of items such as, for example, A and B or A and/or B, means A alone, B alone, or A and B. The term “at least one of” is used to mean one or more of the listed items can be selected.

Terms of relative position as used in this application are defined based on a plane parallel to the conventional plane or working surface of a material (e.g., a layer or a substrate), regardless of orientation. Terms such as “on,” “higher,” “lower,” “over,” “top,” and “under” are defined with respect to the conventional plane or working surface being on the top surface of a layer or substrate, regardless of orientation. The terms “about” or “substantially” indicate that the value or parameter specified may be somewhat altered, as long as the alteration does not result in nonconformance of the process or structure to the illustrated embodiment. Finally, “exemplary” indicates the description is used as an example, rather than implying that it is an ideal. Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

Methods of the invention can be implemented in computer readable instructions, such as program modules or applications, which may be stored in the computer readable medium that is part of (optionally the memory circuitry) or communicatively coupled to the processing circuitry, and executed by the processing circuitry, optionally the processor circuitry. Generally, program modules or applications include routines, programs, objects, data components, data structures, algorithms, and the like, which perform particular tasks or implement particular abstract data types.

### EXAMPLE EMBODIMENTS

An apparatus for reducing error in an inertial system, the apparatus comprising: the inertial system including a package and at least one inertial sensor each of which is attached in and/or on the package; a first set of one or more elastomeric isolators mechanically coupling the package to a chassis; one or more balance weights; and a second set of one or more elastomeric isolators, wherein each of the one or more balance weights is mechanically coupled to the package by one or more elastomeric isolators of the second set.

The apparatus of Example 1, wherein at least one of: (a) a spring constant of the second set, (b) a damping constant of the second set, and (c) a mass of the one or more balance weights is chosen as a function of at least one of: (i) a spring constant of the first set, (ii) a damping constant of the first set, and (iii) a mass of the inertial system.

The apparatus of any of Examples 1-2, wherein at least one of: (a) a spring constant of the first set equals a spring constant of the second set, (b) a damping constant of the first set equals a damping constant of the second set, and (c) a resonant frequency of a combination of the second set of one or more elastomeric isolators and a combination of the one or more proof masses is no more than thirty five percent different than the resonant frequency of the first set of one or more elastomeric isolators and a mass of the inertial system.

The apparatus of any of Examples 1-3, wherein a spring constant and a damping constant of each elastomeric isolator of the first set equals a spring constant and a damping constant of each elastomeric isolator of the second set.

The apparatus of any of Examples 1-4, wherein a mass of the one or more balance weights is greater than three percent of a mass of the inertial system.

The apparatus of any of Examples 1-5, wherein two of the one or more balance weights are mechanically coupled to orthogonal surfaces of the package.

The apparatus of any of Examples 1-6, wherein the at least one inertial sensor includes at least one accelerometer and/or at least one gyroscope.

A method for reducing error in an inertial system, the method comprising: receiving a vibration in the inertial system which is attached to a chassis by a first set of one or more elastomeric isolators, wherein the inertial system includes a package and at least one inertial sensor each of which is attached in and/or on the package; and diminishing an amplitude of the vibration in the inertial system with one or more balance weights each of which is mechanically coupled to the package by at least one of a second set of one or more elastomeric isolators.

The method of Example 8, wherein at least one of: (a) a spring constant of the second set, (b) a damping constant of the second set, and (c) a mass of the one or more balance weights is chosen as a function of at least one of: (i) a spring constant of the first set, (ii) a damping constant of the first set, and (iii) a mass of the inertial system.

The method of any of Examples 8-9, wherein at least one of: (a) a spring constant of the first set equals a spring constant of the second set, (b) a damping constant of the first set equals a damping constant of the second set, and (c) a resonant frequency of a combination of the second set of one or more elastomeric isolators and a combination of the one or more proof masses is no more than thirty five percent different than the resonant frequency of the first set of one or more elastomeric isolators and a mass of the inertial system.

The method of any of Examples 8-10, wherein a spring constant and a damping constant of each elastomeric isolator of the first set equals a spring constant and a damping constant of each of elastomeric isolator of the second set.

The method of any of Examples 8-11, wherein a mass of the one or more balance weights is greater than three percent of a mass of the inertial system.

The method of any of Examples 8-12, wherein two of the one or more balance weights are mechanically coupled to orthogonal surfaces of the package.

The method of any of Examples 8-13, wherein the at least one inertial sensor includes at least one accelerometer and/or at least one gyroscope.

An apparatus for reducing error in an inertial system, the apparatus comprising: a chassis of a vehicle; the inertial system including a package and at least one inertial sensor each of which is attached in and/or on the package, wherein the at least one inertial sensor includes at least one accelerometer and/or at least one gyroscope; a first set of one or more elastomeric isolators mechanically coupling the package to the chassis; one or more balance weights; and a second set of one or more elastomeric isolators, wherein each of the one or more balance weights is mechanically coupled to the package by one or more elastomeric isolators of the second set.

The apparatus of Example 15, wherein at least one of: (a) a spring constant of the second set, (b) a damping constant of the second set, and (c) a mass of the one or more balance weights is chosen as a function of at least one of: (i) a spring constant of the first set, (ii) a damping constant of the first set, and (iii) a mass of the inertial system.

The apparatus of any of Examples 15-16, wherein at least one of: (a) a spring constant of the first set equals a spring constant of the second set, (b) a damping constant of the first set equals a damping constant of the second set, and (c) a resonant frequency of a combination of the second set of one or more elastomeric isolators and a combination of the one or more proof masses is no more than thirty five percent different than the resonant frequency of the first set of one or more elastomeric isolators and a mass of the inertial system.

The apparatus of any of Examples 15-17, wherein a spring constant and a damping constant of each elastomeric isolator of the first set equals a spring constant and a damping constant of each elastomeric isolator of the second set.

The apparatus of any of Examples 15-18, wherein a mass of the one or more balance weights is greater than three percent of a mass of the inertial system.

The apparatus of any of Examples 15-19, wherein two of the one or more balance weights are mechanically coupled to orthogonal surfaces of the package.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. An apparatus for reducing error in an inertial system, the apparatus comprising:
the inertial system including a package and at least one inertial sensor each of which is attached in and/or on the package;
a first set of one or more elastomeric isolators mechanically coupling the package to a chassis;
one or more balance weights; and
a second set of one or more elastomeric isolators, wherein each of the one or more balance weights is mechanically coupled to the package by one or more elastomeric isolators of the second set.

2. The apparatus of claim 1, wherein at least one of: (a) a spring constant of the second set, (b) a damping constant of the second set, and (c) a mass of the one or more balance weights is chosen as a function of at least one of: (i) a spring constant of the first set, (ii) a damping constant of the first set, and (iii) a mass of the inertial system.

3. The apparatus of claim 1, wherein at least one of: (a) a spring constant of the first set equals a spring constant of the second set, (b) a damping constant of the first set equals a damping constant of the second set, and (c) a resonant frequency of a combination of the second set of one or more elastomeric isolators and a combination of the one or more proof masses is no more than thirty five percent different than the resonant frequency of the first set of one or more elastomeric isolators and a mass of the inertial system.

4. The apparatus of claim 1, wherein a spring constant and a damping constant of each elastomeric isolator of the first set equals a spring constant and a damping constant of each elastomeric isolator of the second set.

5. The apparatus of claim 1, wherein a mass of the one or more balance weights is greater than three percent of a mass of the inertial system.

6. The apparatus of claim 1, wherein two of the one or more balance weights are mechanically coupled to orthogonal surfaces of the package.

7. The apparatus of claim 1, wherein the at least one inertial sensor includes at least one accelerometer and/or at least one gyroscope.

8. A method for reducing error in an inertial system, the method comprising:
receiving a vibration in the inertial system which is attached to a chassis by a first set of one or more elastomeric isolators, wherein the inertial system includes a package and at least one inertial sensor each of which is attached in and/or on the package; and
diminishing an amplitude of the vibration in the inertial system with one or more balance weights each of which is mechanically coupled to the package by at least one of a second set of one or more elastomeric isolators.

9. The method of claim 8, wherein at least one of: (a) a spring constant of the second set, (b) a damping constant of the second set, and (c) a mass of the one or more balance weights is chosen as a function of at least one of: (i) a spring constant of the first set, (ii) a damping constant of the first set, and (iii) a mass of the inertial system.

10. The method of claim 8, wherein at least one of: (a) a spring constant of the first set equals a spring constant of the second set, (b) a damping constant of the first set equals a damping constant of the second set, and (c) a resonant frequency of a combination of the second set of one or more elastomeric isolators and a combination of the one or more proof masses is no more than thirty five percent different than the resonant frequency of the first set of one or more elastomeric isolators and a mass of the inertial system.

11. The method of claim 8, wherein a spring constant and a damping constant of each elastomeric isolator of the first set equals a spring constant and a damping constant of each of elastomeric isolator of the second set.

12. The method of claim 8, wherein a mass of the one or more balance weights is greater than three percent of a mass of the inertial system.

13. The method of claim 8, wherein two of the one or more balance weights are mechanically coupled to orthogonal surfaces of the package.

14. The method of claim 8, wherein the at least one inertial sensor includes at least one accelerometer and/or at least one gyroscope.

15. An apparatus for reducing error in an inertial system, the apparatus comprising:
a chassis of a vehicle;
the inertial system including a package and at least one inertial sensor each of which is attached in and/or on the package, wherein the at least one inertial sensor includes at least one accelerometer and/or at least one gyroscope;
a first set of one or more elastomeric isolators mechanically coupling the package to the chassis;
one or more balance weights; and
a second set of one or more elastomeric isolators, wherein each of the one or more balance weights is mechanically coupled to the package by one or more elastomeric isolators of the second set.

16. The apparatus of claim 15, wherein at least one of: (a) a spring constant of the second set, (b) a damping constant of the second set, and (c) a mass of the one or more balance weights is chosen as a function of at least one of: (i) a spring constant of the first set, (ii) a damping constant of the first set, and (iii) a mass of the inertial system.

17. The apparatus of claim 15, wherein at least one of: (a) a spring constant of the first set equals a spring constant of the second set, (b) a damping constant of the first set equals a damping constant of the second set, and (c) a resonant frequency of a combination of the second set of one or more elastomeric isolators and a combination of the one or more proof masses is no more than thirty five percent different than the resonant frequency of the first set of one or more elastomeric isolators and a mass of the inertial system.

18. The apparatus of claim 15, wherein a spring constant and a damping constant of each elastomeric isolator of the first set equals a spring constant and a damping constant of each elastomeric isolator of the second set.

19. The apparatus of claim 15, wherein a mass of the one or more balance weights is greater than three percent of a mass of the inertial system.

20. The apparatus of claim 15, wherein two of the one or more balance weights are mechanically coupled to orthogonal surfaces of the package.
